(19) United States
(12) Patent Application Publication
(10) Pub. No.: US 2025/0253793 A1
(43) Pub. Date: Aug. 7, 2025

(54) DRIVE DEVICE

(71) Applicant: TOYOTA JIDOSHA KABUSHIKI KAISHA, Toyota-shi (JP)

(72) Inventors: Koh OHNO, Toyota-shi (JP); Toshifumi Yamakawa, Okazaki-shi (JP); Hideto Hanada, Okazaki-shi (JP)

(73) Assignee: TOYOTA JIDOSHA KABUSHIKI KAISHA, Toyota-shi (JP)

(21) Appl. No.: 18/965,492

(22) Filed: Dec. 2, 2024

(30) Foreign Application Priority Data
Feb. 5, 2024 (JP) 2024-015883

(51) Int. Cl. H02P 27/08; H02P 21/22; H02P 25/022

(52) U.S. Cl. CPC H02P 27/08; H02P 21/22; H02P 25/022

(57) ABSTRACT

A drive device corrects a d-axis detection current and a q-axis detection current such that a d-axis voltage error between a d-axis estimated voltage based on the torque command and a magnet temperature of the permanent magnet of a motor and a d-axis detection voltage based on the d-axis detection current or a q-axis magnetic flux error between a q-axis estimated magnetic flux based on the torque command and the magnet temperature and a q-axis detection magnetic flux based on the q-axis detection current is a value zero, calculates a d-axis current after the correction and a q-axis current after the correction, and controls the inverter such that a difference between values of the d-axis current after the correction and the q-axis current after the correction and the values of the d-axis current command and the q-axis current command is cancelled out.

### CROSS-REFERENCE TO RELATED APPLICATION

This application claims priority to Japanese Patent Application No. 2024-015883 filed on Feb. 5, 2024, incorporated herein by reference in its entirety.

### BACKGROUND

### 1. Technical Field

The present disclosure relates to a drive device.

### 2. Description of Related Art

Conventionally, a drive device including a motor and an inverter that drives the motor and adapted to apply a temperature of a permanent magnet to a magnetic flux table to obtain a magnetic flux corresponding to the temperature, obtain a torque voltage command (q-axis voltage command) and a magnetized voltage command (d-axis voltage command) such that a difference between values of a torque current command (q-axis current command) and a magnetized current command (d-axis current command) based on the obtained magnetic flux and a torque command and values of a torque current (q-axis detection current) and a magnetized current (d-axis detection current) is cancelled out, and control the inverter has been proposed (see Japanese Unexamined Patent Application Publication No. 9-51700 (JP 9-51700 A), for example).

### SUMMARY

In a case where a sensor error is included in a detection value of a current sensor that detects a phase current of each phase of the motor in such a drive device, a d-axis detection current and a q-axis detection current may deviate from actual values, and a d-axis detection magnetic flux and a q-axis detection magnetic flux based on the d-axis detection current and the q-axis detection current may deviate from actual values, which may affect control of the motor. Therefore, more appropriately correcting the d-axis detection current and the q-axis detection current is one of tasks.

A main object of a drive device of the present disclosure is to more appropriately correct the d-axis detection current and the q-axis detection current.

The drive device according to the present disclosure employs the following mechanisms to achieve the aforementioned main object. The drive device according to the present disclosure is a drive device including: a motor that has a rotor including a permanent magnet embedded in a rotor core and a stator including a three-phase coil wound around a stator core; an inverter that drives the motor; a current sensor that detects a phase current of each phase of the motor; and a control device that controls the inverter based on a d-axis detection current and a q-axis detection current based on a detection value of the current sensor and a d-axis current command and a q-axis current command based on a torque command of the motor. According to the gist, the control device corrects the d-axis detection current and the q-axis detection current such that a d-axis voltage error between a d-axis estimated voltage based on the torque command and a magnet temperature of the permanent magnet and a d-axis detection voltage based on the d-axis detection current or a q-axis magnetic flux error between a q-axis estimated magnetic flux based on the torque command and the magnet temperature and a q-axis detection magnetic flux based on the q-axis detection current is a value zero, calculates a d-axis current after the correction and a q-axis current after the correction, and controls the inverter such that a difference between values of the d-axis current after the correction and the q-axis current after the correction and the values of the d-axis current command and the q-axis current command is cancelled out.

The drive device according to the present disclosure corrects the d-axis detection current and the q-axis detection current such that the d-axis voltage error between the d-axis estimated voltage based on the torque command and the magnet temperature of the permanent magnet and the d-axis detection voltage based on the d-axis detection current or the q-axis magnetic flux error between the q-axis estimated magnetic flux based on the torque command and the magnet temperature and the q-axis detection magnetic flux based on the q-axis detection current is the value zero, calculates the d-axis current after the correction and the q-axis current after the correction, and controls the inverter such that the difference between the values of the d-axis current after the correction and the q-axis current after the correction and the values of the d-axis current command and the q-axis current command is cancelled out. It is thus possible to more appropriately correct the d-axis detection current and the q-axis detection current. The inventors have confirmed these findings through intensive research.

In the drive device according to the present disclosure, the control device may calculate an error property based on the d-axis detection current, the q-axis detection current, and a coefficient such that the d-axis voltage error or the q-axis voltage error is a value zero, and calculate the d-axis current after the correction and the q-axis current after the correction by performing correction using the error property on the d-axis detection current and the q-axis detection current. It is thus possible to more appropriately correct the d-axis detection current and the q-axis detection current using the error property based on the d-axis detection current, the q-axis detection current, and the coefficient.

In the drive device according to the present disclosure, a d-axis magnetic flux after the correction and a q-axis magnetic flux after the correction may be calculated based on the d-axis current after the correction and the q-axis current after the correction.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a battery electric vehicle including a drive device according to an embodiment of the present disclosure;

FIG. 2 is an explanatory diagram illustrating an exemplary state of a magnetic flux when a sensor error of a current sensor is included in a d-axis detection current and a q-axis detection current; and

FIG. 3 is a flowchart illustrating an example of a processing routine.

### DETAILED DESCRIPTION OF EMBODIMENTS

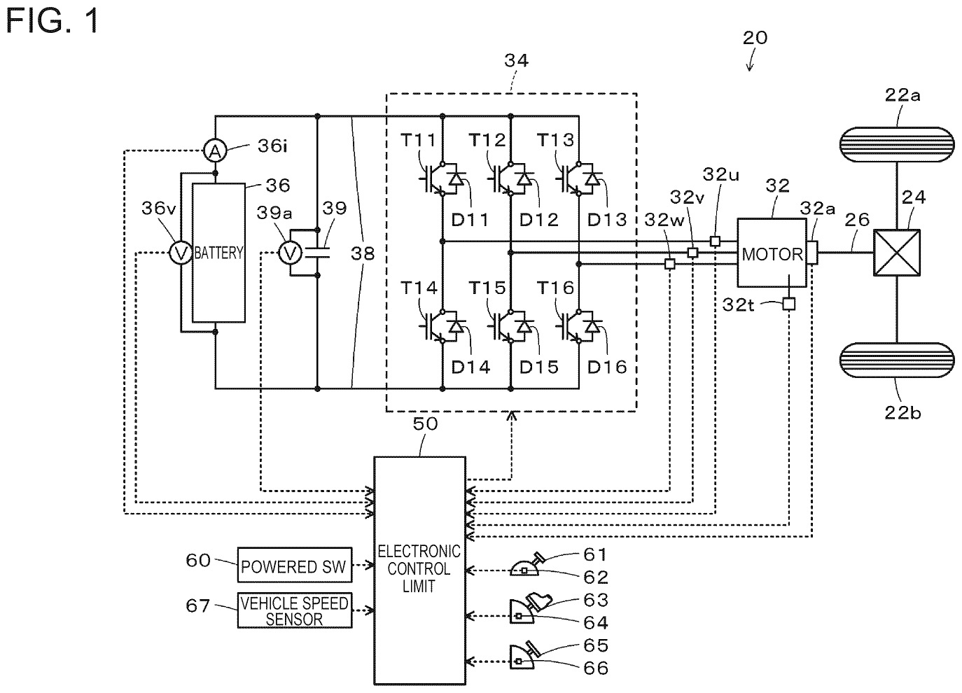

Embodiments for carrying out the present disclosure will be described with reference to the drawings. FIG. 1 is a schematic configuration diagram of a battery electric vehicle 20 including a drive device according to an embodiment of the present disclosure. As illustrated, battery electric vehicle 20 of the embodiment includes a motor 32, an inverter 34, a battery 36 as a power storage device, and an electronic control unit 50 as a control device.

The motor 32 is configured as a three-phase AC motor, and includes a rotor in which a permanent magnet is embedded in a rotor core, and a stator in which a three-phase coil is wound around the stator core. The rotor of the motor 32 is connected to a drive shaft 26 connected to the drive wheel 22a, 22b via a differential gear 24. The inverter 34 is used to drive the motor 32 and is connected to the battery 36 via a power line 38. Inverter 34 includes transistors T11 to T16 as six switching elements, and six diodes D11 to D16 connected in parallel to T16 from six transistors T11. Transistor T11 to T16 are arranged in pairs of two so as to be source side and sink side with respect to the positive side line and negative side line of the power line 38, respectively. Each of the connecting points of the transistors which are the pair of the transistors T11 to T16 is connected to each of the three-phase (U-phase, V-phase, and W-phase) coils of the motor 32. Therefore, when the inverter 34 is energized, the electronic control unit 50 adjusts the ratio of the on-time of T16 from the pair of transistors T11, thereby forming a rotating magnetic field in the three-phase coil and rotationally driving the motor 32. A smoothing capacitor 39 is attached to the power line 38. The battery 36 is configured as a lithium-ion secondary battery or a nickel-hydrogen secondary battery, and is connected to the inverter 34 via the power line 38 as described above.

The electronic control unit 50 includes a microcomputer having a CPU, ROM, RAM, a flash memory, an input/output port, and a communication port, various driving circuitry, and various logic IC. The electronic control unit 50 receives signals from various sensors via input ports. For example, the electronic control unit 50 receives a rotational position θm from a rotational position sensor (for example, a resolver) 32a for detecting a rotational position of a rotor of the motor 32, a phase current Iu, Iv, Iw from a current sensor 32u, 32v, 32w for detecting a phase current of each phase of the motor 32, and a magnet temperature αmag from a temperature sensor 32t for detecting a temperature of a permanent magnet of the motor 32. The electronic control unit 50 also receives a voltage Vb from a voltage sensor 36v mounted between terminals of the battery 36, a current Ib from a current sensor 36i mounted at an output terminal of the battery 36, and a voltage (voltage of the power line 38) VH of a capacitor 39 from a voltage sensor 39a mounted between terminals of the capacitor 39. The electronic control unit 50 also receives a start signal from the power switch 60, a shift position SP from the shift sensor 62 for detecting the operation position of the shift lever 61, an accelerator operation amount Acc from the accelerator pedal position sensor 64 for detecting the depression amount of the accelerator pedal 63, a brake pedal position BP from the brake pedal position sensor 66 for detecting the depression amount of the brake pedal 65, and a vehicle speed V from the vehicle speed sensor 67.

The electronic control unit 50 outputs various control signals via an output port. For example, the electronic control unit 50 outputs a control signal from the transistor T11 to T16 of the inverter 34. The electronic control unit 50 calculates the electric angle θe, the angular velocity om, and the rotational speed Nm of the motor 32 based on the rotational position θm of the rotor of the motor 32 from the rotational position sensor 32a. The electronic control unit 50 calculates the power storage ratio SOC of the battery 36 based on the integrated value of the current Ib of the battery 36 from the current sensor 36i.

In battery electric vehicle 20 of the embodiment configured as described above, the electronic control unit 50 sets the required torque Td* required for the drive shaft 26 based on the accelerator operation amount Acc and the vehicle speed V, sets the set required torque Td* to the torque command Tm* of the motor 32 so as to be outputted to the drive shaft 26, and performs the switching control of T16 from the transistor T11 of the inverter 34 so that the motor 32 is driven by the torque command Tm*.

The electronic control unit 50 basically controls the inverter 34 by pulse-width-modulation control (PWM control). First, the d-axis current command Id* and the q-axis current command Iq* are set based on the torque command Tm* of the motor 32. Subsequently, using the electric angle θe based on the rotational position θm of the rotor of the motor 32 from the rotational position sensor 32a, the phase current Iu, Iv, Iw of each phase of the motor 32 from the current sensor 32u, 32v, 32w is coordinate-converted (three-phase-two-phase conversion) to obtain a d-axis detection current Imsrd and a q-axis detection current Imsrq. Then, the d-axis detection current Imsrd and the q-axis detection current Imsrq are subjected to sensor error correction based on the sensor error of the current sensor 32u, 32v, 32w to obtain the d-axis corrected current Icompd and the q-axis corrected current Icompq. Details of the sensor error correction will be described later. In addition, the d-axis voltage command Vd* and the q-axis voltage command Vq* are calculated so that the difference between the d-axis corrected current Icompd and the q-axis corrected current Icompq and the d-axis current command Id* and the q-axis current command Iq* is cancelled out. Subsequently, the d-axis voltage command Vd* and the q-axis voltage command Vq* using the electric angle θm of the motor 32 coordinate-transformed (2-3 phase transformation), to obtain a phase voltage command Vu*, Vv*, Vw* of each phase. Then, the phase-voltage command Vu*, Vv*, Vw* of each phase is compared with the carrier wave (triangular wave) to perform switching control of transistors T11 to T16 of inverter 34 by generating PWM signals of transistors T11 to T16. Hereinafter, a vector including the d-axis detection current Imsrd and the q-axis detection current Imsrq as components is referred to as a detection current vector Imsr or a detection current vector Imsr (Imsrd, Imsrq). Vectors having other d-axis components and q-axis components are also referred to in the same manner.

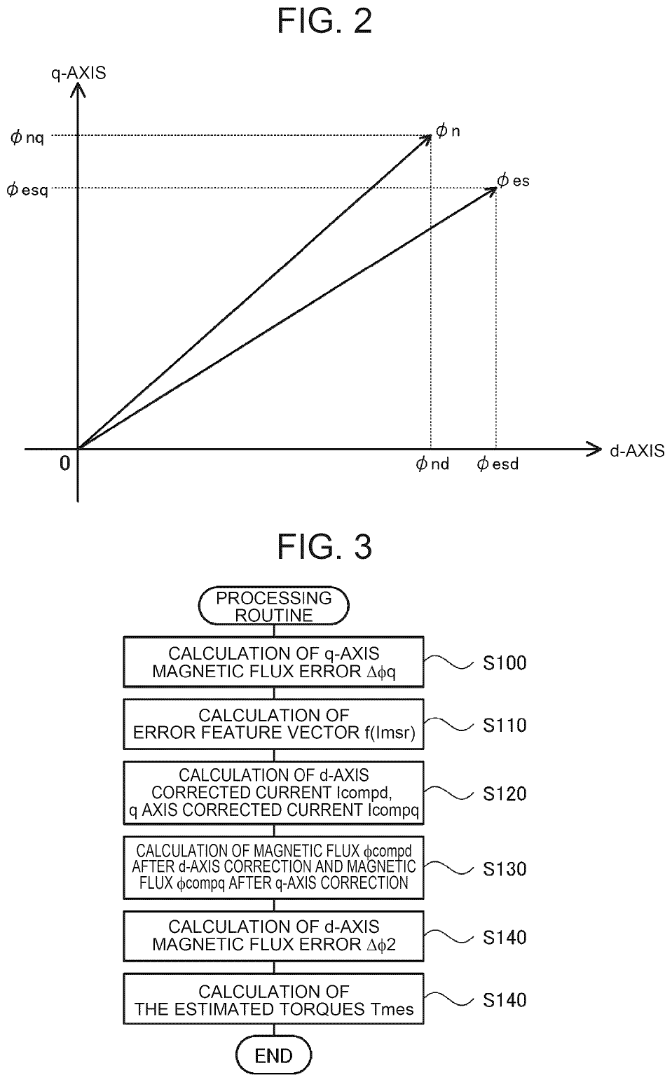

FIG. 2 is an explanatory diagram illustrating an exemplary state of the magnetic flux when the d-axis detection current Imsrd and the q-axis detection current Imsrq include a sensor error (particularly, a gain error) of the current sensor 32u, 32v, 32w. In the figure, the estimated magnetic flux vector φes is a vector having a d-axis estimated magnetic flux φesd and a q-axis estimated magnetic flux φesq as components, and the detected magnetic flux vector φn is a vector having a d-axis detected magnetic flux φnd and a q-axis detected magnetic flux φnq as components.

The d-axis estimated magnetic flux φesd and the q-axis estimated magnetic flux φesq are the d-axis magnetic flux and the q-axis magnetic flux based on the torque command Tm* and the magnet temperature αmag of the motor 32. The d-axis estimated magnetic flux φesd and the q-axis estimated magnetic flux φesq can be estimated (derived) using, for example, the torque command Tm* and the magnet temperature αmag and the estimated magnetic flux map. The estimated magnetic flux map is determined in advance by experimentation, analysis, machine learning, or the like as a relation between the torque command Tm* and the magnet temperature αmag of the motor 32 and the d-axis estimated magnetic flux φesd and the q-axis estimated magnetic flux φesq. The d-axis estimated magnetic flux φesd and the q-axis estimated magnetic flux φesq can be calculated by various known methods. In the embodiment, the d-axis estimated magnetic flux φesd and the q-axis estimated magnetic flux φesq can simulate the d-axis real magnetic flux φreald and the q-axis real magnetic flux φrealq with sufficiently high accuracy. The d-axis real magnetic flux φreald and the q-axis real magnetic flux φrealq are the d-axis magnetic flux and the q-axis magnetic flux based on the d-axis real current Ireald and the q-axis real current Irealq and the magnet magnetic flux (φmag+Δφmag) based on the magnet temperature αmag. “φmag” is a magnet magnetic flux (magnet magnetic flux base value) when the magnet temperature αmag is at the reference temperature, and Δφmag is a change amount (magnet magnetic flux change amount) of the magnet magnetic flux based on the magnet temperature αmag.

The d-axis detection magnetic flux φnd and the q-axis detection magnetic flux φnq are the d-axis magnetic flux and the q-axis magnetic flux based on the d-axis detection current Imsrd and the q-axis detection current Imsrq. The d-axis detection magnetic flux φnd and the q-axis detection magnetic flux φnq can be derived using, for example, the d-axis detection current Imsrd, the q-axis detection current Imsrq, and the detection magnetic flux map. The detected magnetic flux map is determined in advance by experimentation, analysis, machine-learning, or the like as a relation between the d-axis detected current Imsrd and the q-axis detected current Imsrq, and the d-axis detected magnetic flux φnd and the q-axis detected magnetic flux φnq. Note that the d-axis detection magnetic flux φnd and the q-axis detection magnetic flux φnq may be calculated by Equation (1) and Equation (2) using the d-axis detection current Imsrd and the q-axis detection current Imsrq, the d-axis inductance Ld, the q-axis inductance Lq, and the magnetic flux base value φmag.

$$φ nd = Ld \cdot Imsrd + φ mag \qquad ( 1 )$$

$$φ nq = Lq \cdot Imsrq \qquad ( 2 )$$

When the d-axis detection current Imsrd and the q-axis detection current Imsrq include a sensor error (particularly, a gain error) of the current sensor 32u, 32v, 32w, as shown in FIG. 2, the estimated magnetic flux vector φes (φesd, φesq) and the detected magnetic flux vector φn (φnd, φnq) can be deviated from each other. In this case, the d-axis magnetic flux error Δφd (=φnd−φesd) between the d-axis estimated magnetic flux φesd and the d-axis detected magnetic flux φnd may include not only the influence of the sensor error but also the influence of the magnetic flux change amount Δφmag. On the other hand, it is considered that the q-axis magnetic flux error Δφq (=φnq−φesq) between the q-axis estimated magnetic flux φesq and the q-axis detected magnetic flux φnq includes only the influence of the sensor error. The inventors have confirmed these findings through intensive studies. Therefore, it is considered that the d-axis corrected current Icompd and the q-axis corrected current Icompq can be calculated more appropriately by performing sensor error correction on the d-axis detected current Imsrd and the q-axis detected current Imsrq and calculating t the d-axis corrected current Icompd and the q-axis corrected current Icompq so that the q-axis magnetic flux error Δφq becomes 0. Further, if the estimated torque Tmes of the motor 32 is calculated based on the d-axis corrected current Icompd and the q-axis corrected current Icompq, it is considered that the estimated torque Tmes can be calculated more appropriately.

Hereinafter, a method of calculating the d-axis corrected current Icompd and the q-axis corrected current Icompq and calculating the estimated torque Tmes will be described. FIG. 3 is a flowchart illustrating an example of a processing routine by the electronic control unit 50. This routine is repeatedly executed.

When the process of FIG. 3 is executed, the electronic control unit 50 first calculates a q-axis magnetic flux error Δφq (S100). In this process, in the embodiment, the q-axis magnetic flux error Δφq is calculated by dividing the d-axis voltage error ΔVd (=Vnd−Vesd) between the d-axis estimated voltage Vesd and the d-axis detection voltage Vnd by the angular velocity @m.

The d-axis estimated voltage Vesd and the q-axis estimated voltage Vesq described later are the d-axis voltage and the q-axis voltage based on the torque command Tm* and the magnet temperature αmag of the motor 32. The d-axis estimated voltage Vesd and the q-axis estimated voltage Vesq can be estimated (derived) using, for example, the torque command Tm* and the magnet temperature αmag and the estimated voltage map. The estimated voltage map is determined in advance by experimentation, analysis, machine learning, or the like as a relation between the torque command Tm* and the magnet temperature αmag of the motor 32 and the d-axis estimated voltage Vesd and the q-axis estimated voltage Vesq. The d-axis estimated voltage Vesd and the q-axis estimated voltage Vesq can be calculated by various known methods. In the embodiment, the d-axis estimated voltage Vesd and the q-axis estimated voltage Vesq can simulate the d-axis real voltage Vreald and the q-axis real voltage Vrealq with sufficiently high accuracy. The d-axis real voltage Vreald and the q-axis real voltage Vrealq are the d-axis voltage and the q-axis voltage based on the d-axis real current Ireald and the q-axis real current Irealq and the magnet magnetic flux (φmag+Δφmag) based on the magnet temperature αmag.

The d-axis detection voltage Vnd and the q-axis detection voltage Vnq for reference can be calculated by Equations (3) and (4) using, for example, the d-axis detection magnetic flux φnd and the q-axis detection magnetic flux φnq, the time change rates dφnd, dφnq, the angular velocity om, the electric element resistance Rs, the d-axis detection current Imsrd, and the q-axis detection current Imsrq. Therefore, since the d-axis voltage error ΔVd can be expressed by Equation (5), the q-axis magnetic flux error Δφq can be calculated by Equation (6).

$$Vnd = d φ nd - ω m \cdot φ nq + Rs \cdot Imsrd \qquad ( 3 )$$

$$Vnq = d φ nq + ω m \cdot φ nd + Rs \cdot Imsrq \qquad ( 4 )$$

$$Δ Vd = Vdn - Vesd = ( d φ nd - ω m \cdot φ nq + Rs \cdot Imsrd ) - Vesd \qquad ( 5 )$$

$$Δφ q = Δ Vd / ω m = [ ( d φ nd - ω m \cdot φ nq + Rs \cdot Imsrd ) - Vesd ] / ω m \qquad ( 6 )$$

Subsequently, the error characteristic vector f(Imsr) of the sensor error is calculated (S110). In the embodiment, the error property vector f(Imsr) is based on the detected current vector Imsr. Further, the actual current vector Ireal is defined as the sum of the detected current vector Imsr and the error property vector f(Imsr) as shown in Equation (7). Furthermore, the error property vector f(Imsr) was defined as the product of the detected current vector Imsr and the factor α1 as shown in Equation (8). Therefore, the error property vector f(Imsr) is the product of the detected current vector Imsr and the value (1+α1). In S110 process, in the embodiment, as shown in Equation (9) corresponding to Equation (6), the detected current vector Imsr is replaced with the sum of the detected current vector Imsr and the error characteristic vector f(Imsr), and the error characteristic vector f(Imsr) is calculated so that the q-axis magnetic flux error Δφq becomes 0. In Equation (9), “dφnd” and “φnq” in addition to “Imsrd” are also based on the detected current vector Imsr, and the coefficient α1 of the error characteristic vector f(Imsr) is calculated by solving Equation (9).

$$Ireal = Imsr + f ( Imsr ) \qquad ( 7 )$$

$$f ( Imsr ) = α 1 \cdot Imsr \qquad ( 8 )$$

$${Δφ q = [ ( ( d φ nd - ω m \cdot φ nq + Rs \cdot Imsrd ) - Vesd ) / ω m ] \vert}_{Imsr \to Imsr + f ( Imsr )} = 0 \qquad ( 9 )$$

When the error characteristic vector f(Imsr) is calculated in this way, as shown in Equation (10), the sensor error is corrected using the error characteristic vector f(Imsr) with respect to the detected current vector Imsr, and the corrected current vector Icomp is calculated (S120). With such a method, the d-axis corrected current Icompd and the q-axis corrected current Icompq can be calculated more appropriately. Specifically, the d-axis corrected current Icompd and the q-axis corrected current Icompq can be calculated so as to eliminate the sensor error.

Icomp=Imsr+f(Imsr) (10)

When the d-axis corrected current Icompd and the q-axis corrected current Icompq are calculated in this manner, the d-axis corrected magnetic flux φcompd and the q-axis corrected magnetic flux φcompq are calculated based on the calculated d-axis corrected current Icompd and the q-axis corrected current Icompq (S130). The calculation method of the d-axis corrected magnetic flux φcompd and the q-axis corrected magnetic flux φcompq is the same as the calculation method of the d-axis detected magnetic flux φnd and the q-axis detected magnetic flux φnq. The d-axis corrected magnetic flux φcompd and the q-axis corrected magnetic flux φcompq can be derived using, for example, the d-axis corrected current Icompd and the q-axis corrected current Icompq and a corrected magnetic flux map. The corrected magnetic flux map is a map in which the d-axis detection current Imsrd, the q-axis detection current Imsrq, the d-axis detection magnetic flux φnd, and the q-axis detection magnetic flux φnq of the above-described detection magnetic flux map are replaced with the d-axis corrected current Icompd, the q-axis corrected current Icompq, the d-axis corrected magnetic flux φcompd, and the q-axis corrected magnetic flux φcompq. As described above, the d-axis magnetic flux error Δφd (=φnd−φesd) between the d-axis estimated magnetic flux φesd and the d-axis detected magnetic flux φnd may include not only the influence of the sensor error but also the influence of the magnetic flux change amount Δφmag. On the other hand, it is considered that the q-axis magnetic flux error Δφq (=φnq−φesq) between the q-axis estimated magnetic flux φesq and the q-axis detected magnetic flux φnq includes only the influence of the sensor error. Therefore, by calculating the d-axis corrected current Icompd and the q-axis corrected current Icompq so as to eliminate the sensor error, the q-axis magnetic flux error Δφq2 (=φcompq−φesq) between the q-axis estimated magnetic flux φesq and the q-axis corrected magnetic flux φcompq becomes approximately 0, and the d-axis magnetic flux error Δφd2 (=φcompd−φesd) between the d-axis estimated magnetic flux φesd and the d-axis corrected magnetic flux @compd does not include the influence of the sensor error and includes the influence of the magnetic flux change amount Δφmag. That is, the d-axis corrected magnetic flux φcompd and the q-axis corrected magnetic flux φcompq can be calculated so as to eliminate the sensor error.

Subsequently, the d-axis magnetic flux error Δφd2 is calculated (S140). In this process, in the embodiment, the d-axis magnetic flux error Δφd2 is calculated by dividing the q-axis voltage error ΔVq (=Vcompq−Vesq) between the q-axis estimated voltage Vesq and the q-axis corrected voltage Vcompq by the angular velocity ωm. The q-axis corrected voltage Vcompq can be calculated by Equation (11) using the time-change rate dφcompq, the angular velocity om, the electric element resistance Rs, and the q-axis corrected current Icompq of the d-axis corrected magnetic flux φcompd and the q-axis corrected magnetic flux φcompq. Therefore, since the q-axis voltage error ΔVq2 can be expressed by Equation (12), the d-axis magnetic flux error Δφd2 can be calculated by Equation (13). The d-axis magnetic flux error Δφd2 calculated in this way is considered to substantially correspond to the magnetic flux change amount Δφmag.

$$Vcompq = d φ compq + ω m \cdot φ compq + Rs \cdot Icompq \qquad ( 11 )$$

$$Δ Vq 2 = Vcompd - Vesd = ( d φ compq + ω m \cdot φ compd + Rs \cdot Icompq ) - Vesq \qquad ( 12 )$$

$$Δφ d 2 = Δ Vq 2 / ω m = [ ( d φ compq + ω m \cdot φ compd + Rs \cdot Icompq ) - Vesq ] / ω m \qquad ( 13 )$$

When the d-axis magnetic flux error Δφd2 is calculated in this manner, the estimated torque Tmes of the motor 32 is calculated by Equation (14) using the pole logarithm Np of the motor 32, the d-axis corrected current Icompd, the q-axis corrected current Icompq, the d-axis corrected magnetic flux φcompd, the q-axis corrected magnetic flux φcompq, and the d-axis corrected magnetic flux error Δφd2 (S150), and the routine is ended. In Equation (14), “φcompd+Δφd2” corresponds to the d-axis magnetic flux in consideration of the influence of the magnetic flux change amount Δφmag, and is considered to be substantially equal to the d-axis estimated magnetic flux φesd. By calculating the estimated torque Tmes in this manner, the estimated torque Tmes can be calculated more appropriately.

$$Tmes = Np \cdot [ ( φ compd + Δφ d 2 ) \cdot Icompq - φ compq \cdot Icompd ] \qquad ( 14 )$$

In the drive device provided in battery electric vehicle 20 of the present embodiment described above, the error characteristic vector f(Imsr) is calculated so that the q-axis magnetic flux error Δφq(=φnq−φesq) between the q-axis estimated magnetic flux φesq and the q-axis detected magnetic flux φnq becomes 0. Further, the detected current vector Imsr is subjected to sensor error correction using the error characteristic vector f (Imsr) to calculate the corrected current vector Icomp. Thus, the d-axis corrected current Icompd and the q-axis corrected current Icompq can be calculated more appropriately. Specifically, the d-axis corrected current Icompd and the q-axis corrected current Icompq can be calculated so as to eliminate the sensor error.

Further, the drive device calculates the d-axis corrected magnetic flux φcompd and the q-axis corrected magnetic flux φcompq based on the d-axis corrected current Icompd and the q-axis corrected current Icompq. Thus, the d-axis corrected magnetic flux φcompd and the q-axis corrected magnetic flux φcompq can be calculated more appropriately. Specifically, the d-axis corrected magnetic flux φcompd and the q-axis corrected magnetic flux φcompq can be calculated so as to eliminate the sensor error.

In the above-described embodiment, the q-axis magnetic flux error Δφq is calculated by the above-described Equation (6), but the present disclosure is not limited thereto. For example, the q-axis magnetic flux error Δφq may be calculated by any of the following methods (A1) to (A4).

The method (A1) will be described. In this method, the q-axis magnetic flux error Δφq is calculated by subtracting the q-axis estimated magnetic flux φesq based on the torque command Tm* of the motor 32 and the magnet temperature αmag from the q-axis detected magnetic flux φnq based on the d-axis detected current Imsrd and the q-axis detected current Imsrq.

The method (A2) will be described. In this method, partial regression coefficients θ1 and θ2 in Equation (15) where the objective variable is “dφnd−Vesd”, the independent variable is “Imsrd” and “ωm”, and the partial regression coefficients are “θ1” and “θ2” are estimated using multiple regression analysis or a sequential estimation method. Then, the regression coefficient θ2 corresponding to the angular velocity om is set to the q-axis estimated magnetic flux φesq, and the q-axis magnetic flux error Δφq is calculated by “Δφq=φnq−φesq”. Examples of the multiple regression analysis include a least squares method, a nonlinear least squares method, and the like. Examples of the sequential estimation method include a sequential least squares method and Kalman filtering. By using the partial regression coefficients θ1 and θ2, estimation independent of the error effect of the linear voltage-drop components (e.g., “Rs·Imsrd”) due to the current can be performed, and therefore, it is robust to parameter errors other than the magnetic flux.

$$d φ nd - Vesd = θ1 \cdot Imsrd + θ2 \cdot ω m \qquad ( 15 )$$

The method (A3) will be described. In this method, the objective variable is defined as “dφnd−Vesd−ωm·φnq+Rs·Imsrd”, the independent variable is defined as “Imsrd” and “ωm”, and the partial regression coefficients θ3 and θ4 in Equation (16) where the partial regression coefficients are defined as “θ3” and “θ4” are estimated using multiple regression analysis or a sequential estimation method. Then, a value (−θ4) obtained by inverting the sign of the regression coefficient θ2 corresponding to the angular velocity om is set to the q-axis magnetic flux error Δφq. By using the partial regression coefficients θ3 and θ4, it becomes robust against parameter errors other than magnetic flux, as in the method (A1).

$$d φ nd - Vesd - ω m \cdot φ nq + Rs \cdot Imsrd = θ3 \cdot Imsrd + θ4 \cdot ω m \qquad ( 16 )$$

The method (A4) will be described. In this method, “ωm” of an independent variable in the above-described method (A1) or the method (A2) is replaced with “ωm·φnq”. Thus, the q-axis magnetic flux error Δφq can be analyzed as a coefficient.

In the above-described embodiment, the error feature vector f(Imsr) is calculated by Equation (9) corresponding to Equation (6), but the present disclosure is not limited thereto. For example, as shown in Equation (17) corresponding to Equation (5), the detected current vector Imsr may be replaced with the sum of the detected current vector Imsr and the error characteristic vector f(Imsr), and the error characteristic vector f(Imsr) may be calculated so that the d-axis voltage error ΔVd becomes 0.

$${Δ Vd = [ ( d φ nd - ω m \cdot φ nq + Rs \cdot Imsrd ) - Vesd ] \vert}_{Imsr \to Imsr + f ( Imsr )} = 0 \qquad ( 17 )$$

In the above-described embodiment, the error characteristic vector f(Imsr) is defined as Equation (8) using the detected current vector Imsr and the coefficient α1, but the present disclosure is not limited thereto. For example, the error property vector f(Imsr) may be defined as in Equation (18) using the detected current vector Imsr, the factor α1, and the constant α0. Further, the error property vector f(Imsr (Imsrd, Imsrq)) may be defined as in Equation (19) using the detected current vector Imsr(Imsrd, Imsrq) and the coefficient αn(n:0, . . . , N). Furthermore, the error characteristic vector f(Imsr (Imsrd, Imsrq)) may be defined by using the detected current vector Imsr(Imsrd, Imsrq), the coefficient αn(n:0, . . . , N), the state vector Xp(p:0, . . . , P), and the coefficient βp as shown in Equation (20). The status vector Xp is a vector containing the d-axis element Xpd and the q-axis element Xpq as components. The P-value and the status vector Xp can be arbitrarily set. As an example of Equation (20), it is conceivable to set the value N to 1, set the value P to 0, set the state vector X0 to “X0=sin(Imsrd)·|ωm|, sin(Imsrq)·|ωm|”, and define the error characteristic vector f(Imsr, om) as Equation (21). In this case, the coefficients α0, α1, and β0 are calculated by solving Equation (9) or Equation (17).

$$f ( Imsr ) = α1 \cdot Ismr + α0 \qquad ( 18 )$$

$$\begin{matrix}( Equation 1 ) & \\ f ( {I}_{m s r} ( {I}_{m s r d} , {I}_{m s r q} ) ) = {\sum }_{n = 0}^{N} {α}_{n} \cdot ( {I}_{m s r d}^{n} , {I}_{m s r q}^{n} ) & ( 19 )\end{matrix}$$

$$\begin{matrix}( Equation 2 ) & \\ f ( {I}_{m s r} , {X}_{m} ) = {\sum }_{n = 0}^{N} {α}_{n} \cdot ( {I}_{m s r d}^{n} , {I}_{m s r q}^{n} ) + {\sum }_{p = 0}^{P} {β}_{p} \cdot {X}_{p} & ( 20 )\end{matrix}$$

$$f ( Imsr , ω m ) = ( α1 \cdot Imsrd + α 0 , α1 \cdot Imsrq + α0 ) + ( β0 \cdot sin ( Imsrd + α0 , α1 \cdot Imsrq + α0 ) + ( β0 \cdot sin ( Imsrd ) \cdot \vert ω m \vert , β0 \cdot sin ( Imsrq ) \cdot \vert ω m \vert ) \qquad ( 21 )$$

In the above-described embodiment, the d-axis magnetic flux error Δφd2 is calculated by the above-described Equation (13), but the present disclosure is not limited thereto. For example, the q-axis magnetic flux error Δφq may be calculated by any of the following methods (B1) to (B4).

The method (B1) will be described. In this method, the d-axis magnetic flux error Δφd2 is calculated by subtracting the d-axis estimated-voltage Vesd from the d-axis corrected magnetic flux φcompd.

The method (B2) will be described. In this method, partial regression coefficients θ5 and θ6 in Equation (23) where the objective variable is “dφcompq−Vesq”, the independent variable is “Icompq” and “ωm”, and the partial regression coefficients are “θ5” and “θ6” are estimated using multiple regression analysis or a sequential estimation method. Then, the regression coefficient θ6 corresponding to the angular velocity ωm is set to the d-axis estimated magnetic flux φesd, and the d-axis magnetic flux error Δφd2 is calculated by “Δφd2=φcompd−φesd”. At this time, since the polarization coefficient θ5 corresponds to the electric element corrected resistance Rcomps which is the estimated value (corrected value) of the electric element resistance Rs, in addition to the d-axis estimated magnetic flux φesd and the d-axis magnetic flux error Δφd2, the electric element corrected resistance Rcomps can also be calculated. When the electric element resistance Rcomps is estimated in this way, the electric element corrected resistance Rcomps may be used instead of the electric element resistance Rs in the subsequent processing (including the subsequent execution of the processing routine of FIG. 3).

$$d φ compq - Vesq = θ5 \cdot Icompq + θ6 \cdot ω m \qquad ( 22 )$$

The method (B3) will be described. In this method, the objective variable is defined as “dφcompq−Vesq−ωm·φcompd+Rcomps·Icompq”, the independent variable is defined as “Iq*” and “ωm”, and the partial regression coefficients θ7 and θ8 in Equation (23) where the partial regression coefficients are defined as “θ7” and “θ8” are estimated using multiple regression analysis or a sequential estimation method. Then, the regression coefficient θ8 corresponding to the angular velocity ωm is set to the d-axis magnetic flux error Δφd2. At this time, since the polarization regression coefficient θ7 corresponds to the resistance Rcomps after the electric element correction, in addition to the d-axis magnetic flux error Δφd2, the resistance Rcomps after the electric element correction can also be calculated.

$$d φ compq - Vesq - ω m \cdot φ compd + Rcomps \cdot Icompq = θ5 \cdot Icompq + θ6 \cdot ω m \qquad ( 23 )$$

The method (B4) will be described. In this method, “Icompq” and “ωm” of the independent variables in the above-described method (B1) and method (B2) are replaced with “Rcomps·Icompq” and “ωm·φcompd”. Thus, the d-axis magnetic flux error Δφd2 can be analyzed as a coefficient.

In the above-described embodiment, the estimated torque Tmes is calculated by Equation (14) described above, but the present disclosure is not limited thereto. For example, the estimated torque Tmes may be calculated by Equation (24) in which “φcompd+Δφd2” and “φcompq” in Equation (14) are replaced with “φesd” and “φesq”, respectively. Further, the estimated torque Tmes may be calculated by Equation (25) in which “φcompd+Δφd2” and “φcompq” in Equation (14) are replaced with “Ld·Icompd+φmag+Δφd2” and “Lq·Icompq”, respectively. Further, the power Pm of the motor 32 may be calculated based on the d-axis corrected current Icompd and the q-axis corrected current Icompq and the d-axis estimated voltage Vesd and the q-axis estimated voltage Vesq, and the estimated torque Tmes may be calculated by subtracting the lost Ploss of the motor 32 from the power Pm and further dividing by the angular velocity om as shown in Equation (26). Alternatively, as shown in Equation (27), the estimated torque Tmes may be calculated by subtracting the torque obtained by dividing the loss Ploss by the angular velocity om from the torque obtained by dividing the power Pm by the angular velocity. In addition, when the motor 32 is controlled so that the d-axis current becomes 0, such as during the copper loss minimum control, the estimated torque Tmes may be calculated by Equation (28) using the torque constant Kt=Np·(φcompd+Δφd2).

$$Tmes = Np \cdot ( φ esd \cdot Icompq - φ esq \cdot Icompd ) \qquad ( 24 )$$

$$Tmes = Np \cdot [ ( Ld \cdot Icompd + φ mag + Δφ d ) \cdot Icompq - ( Lq \cdot Icompq ) \cdot Icompd ] \qquad ( 25 )$$

$$Tmes = ( Pm - Ploss ) / ω m \qquad ( 26 )$$

$$Tmes = Pm / ω m - Ploss / ω m \qquad ( 27 )$$

$$Tmes = Kt \cdot Icompq = Np \cdot ( φ compd + Δφ d 2 ) \cdot Icompq \qquad ( 28 )$$

In the above-described embodiment, a battery is used as the power storage device, but the present disclosure is not limited thereto. For example, a capacitor or the like may be used as the power storage device. In the above-described embodiment, the drive device is mounted on battery electric vehicle 20, but the present disclosure is not limited thereto. For example, in addition to the configuration similar to that of battery electric vehicle 20, the drive device may be mounted on a hybrid electric vehicle that further includes an engine. In addition to the configuration similar to that of battery electric vehicle 20, the drive device may be mounted on a fuel cell electric vehicle that further includes a fuel-cell.

Although the embodiments for carrying out the present disclosure have been described using the embodiments, it is needless to say that the present disclosure is not limited to such embodiments, and can be implemented in various forms without departing from the gist of the present disclosure.

The present disclosure is applicable to a manufacturing industry of a drive device and the like.

What is claimed is:

1. A drive device comprising:
a motor that has a rotor including a permanent magnet embedded in a rotor core and a stator including a three-phase coil wound around a stator core;
an inverter that drives the motor;
a current sensor that detects a phase current of each phase of the motor; and
a control device that controls the inverter based on a d-axis detection current and a q-axis detection current based on a detection value of the current sensor and a d-axis current command and a q-axis current command based on a torque command of the motor, wherein the control device corrects the d-axis detection current and the q-axis detection current such that a d-axis voltage error between a d-axis estimated voltage based on the torque command and a magnet temperature of the permanent magnet and a d-axis detection voltage based on the d-axis detection current or a q-axis magnetic flux error between a q-axis estimated magnetic flux based on the torque command and the magnet temperature and a q-axis detection magnetic flux based on the q-axis detection current is a value zero, calculates a d-axis current after the correction and a q-axis current after the correction, and controls the inverter such that a difference between values of the d-axis current after the correction and the q-axis current after the correction and the values of the d-axis current command and the q-axis current command is cancelled out.

2. The drive device according to claim 1, wherein the control device calculates an error property based on the d-axis detection current, the q-axis detection current, and a coefficient such that the d-axis voltage error or the q-axis magnetic flux error is a value zero, and calculates the d-axis current after the correction and the q-axis current after the correction by performing correction using the error property on the d-axis detection current and the q-axis detection current.

3. The drive device according to claim 1 wherein the control device calculates a d-axis magnetic flux after the correction and a q-axis magnetic flux after the correction based on the d-axis current after the correction and the q-axis current after the correction.
